(19) United States
(12) Patent Application Publication
(10) Pub. No.: US 2006/0184930 A1
(43) Pub. Date: Aug. 17, 2006

(54) Coordinating software upgrades in distributed systems

(76) Inventors: Carlos F. Fuente, Portsmouth (GB); Robert B. Nicholson, Southsea (GB); William J. Scales, Fareham (GB)

Correspondence Address: DILLION & YUDELL, LLP, 8911 N CAPITAL OF TEXAS HWY, SUITE 2110, AUSTIN, TX, 78759, US

(21) Appl. No.: 11/351,046

(22) Filed: Feb. 9, 2006

(30) Foreign Application Priority Data
Feb. 11, 2005 (GB) 0502842.8

(51) Int. Cl. G06F 9/44; G06F 9/445

(52) U.S. Cl. 717/168; 717/174

(57) ABSTRACT

A method for software upgrade in a first node operable in a distributed computing system is disclosed. The method comprises receiving, by a receiving component, a new version of application software and a new version of infrastructure software and installing, by an installation component, the new version of application software and the new version of infrastructure software. A first startup component starts the new version of infrastructure software. A second startup component starts an old version of application software to run with the new version of the infrastructure software. Responsive to an indication from a second node that the new version of application software and the new version of infrastructure software have been installed at the second node, the old version of application software is quiesced by a transition component. The old version is unloaded the new version of application software is loaded.

This application claims priority from United Kingdom patent application No. GB0502842.8, filed on Feb. 11, 2005, and entitled, “Coordinating Software Upgrades in Distributed Systems.”

### BACKGROUND OF THE INVENTION

1. Technical Field

This invention relates to the field of coordinating software upgrades in distributed systems. In particular, the invention relates to coordinating software upgrades with minimal disruption to the distributed system.

2. Description of the Prior Art

Distributed computer systems have become more widespread as computer networks have developed. Distributed computer systems comprise multiple computer systems connected by one or more networks such that the resources of the computer systems can be shared, and processes instructed by a local computer system can be executed on a remote computer system. The connecting networks can include Local Area Networks (LANs), Wide Area Networks (WANs) and global networks such as the Internet. One benefit of these systems is that they can provide better scalability and fault tolerance than monolithic systems.

A known problem in these systems is that of managing software upgrade with the least possible disruption to service. Many distributed systems mandate a period of down time to upgrade software, and only a few support continuous service availability through this procedure. Sometimes this capability is known as concurrent code load.

In those systems that support concurrent code load, in order to maintain service availability, a common technique employed is to apply the software to a single node in the distributed system at a time. Service is maintained through other nodes in the system while each node in turn is applying the software update and is therefore inoperative.

A natural consequence of this is that, for a period of time, two different software versions are executing on the multiple nodes in the system. These two versions must continue to interoperate correctly. Typically this is handled by having conditional behaviour based on some version information captured at initialisation, but this increases code complexity significantly, and so this presents a significant challenge in system design and also testing.

To try to contain the effort, a typical restriction is that software upgrade is only supported from a few earlier versions, or possibly only from one earlier version. To upgrade from a very old software version to the latest version requires the customer to perform an upgrade through each intermediate version to reach the latest one.

It would thus be desirable to have a logic arrangement, method or program to permit upgrades to software in distributed systems, while alleviating these disadvantages.

### SUMMARY OF THE INVENTION

A method for software upgrade in a first node operable in a distributed computing system is disclosed. The method comprises receiving, by a receiving component, a new version of application software and a new version of infrastructure software and installing, by an installation component, the new version of application software and the new version of infrastructure software. A first startup component starts the new version of infrastructure software. A second startup component starts an old version of application software to run with the new version of the infrastructure software. Responsive to an indication from a second node that the new version of application software and the new version of infrastructure software have been installed at the second node, the old version of application software is quiesced by a transition component. The old version is unloaded the new version of application software is loaded.

### BRIEF DESCRIPTION OF THE DRAWINGS

Embodiments of the invention are now described, by way of example only, with reference to the accompanying drawings in which:

FIG. 1 is a diagram of a configuration comprising nodes in which the teaching of the present invention may be practised; and

FIG. 2 is a flow diagram of a method for operating the apparatus in accordance with a preferred embodiment of the present invention.

### DETAILED DESCRIPTION OF THE PREFERRED EMBODIMENT

The preferred embodiment of the present invention contemplates the separation of the software into two elements, a high level application and low level infrastructure software. High level application software is typically used to perform the functions directly required and largely understood at the end-user or customer level. Low level infrastructure software is typically concerned with control of system-level functions and such operations as system, memory and device control. The high level application software is typically packaged as a shared library which can be loaded and unloaded by the low level infrastructure software. The interface representing available functions provided by the low level infrastructure for use by the high level application software is preferably structured in such a way that it can support a range of versions of high level application shared libraries.

According to a first aspect of the present invention there is provided a logic arrangement for software upgrade in a node operable in a distributed computing system, comprising: a receiving component for receiving a new version of application software and a new version of infrastructure software; an installation component for installing the new version of application software and the new version of infrastructure software; a first startup component for starting the new version of infrastructure software; a second startup component for starting an old version of application software to run with the new version of infrastructure software; and a transition component, responsive to an indication from a further node that the new version of application software and the new version of infrastructure software have been installed at the further node, for quiescing the old version of application software, unloading the old version of application software and loading the new version of application software.

The logic arrangement preferably comprises a communication component for sending an indication to a further node that the new version of application software and the new version of infrastructure software have been installed at the node.

Preferably, the node comprises a data storage apparatus.

Preferably, the data storage apparatus comprises a storage controller apparatus.

Preferably, the data storage apparatus comprises a storage virtualization controller apparatus.

Preferably, the node comprises a host processing apparatus.

Preferably, at least one of the old version of application software and the new version of application software comprises a shared library.

In a second aspect, the present invention provides a method for software upgrade in a node operable in a distributed computing system, comprising the steps of: receiving, by a receiving component, a new version of application software and a new version of infrastructure software; installing, by an installation component, the new version of application software and the new version of infrastructure software; starting, by a first startup component, the new version of infrastructure software; starting, by a second startup component, an old version of application software to run with the new version of infrastructure software; starting, by a second startup component, an old version of application software to run with the new version of infrastructure software; and responsive to an indication from a further node that the new version of application software and the new version of infrastructure software have been installed at the further node, quiescing, by a transition component, the old version of application software, unloading the old version of application software and loading the new version of application software.

The method preferably comprises the step of sending an indication to a further node that the new version of application software and the ne version of infrastructure software have been installed at the node.

Preferably, the node comprises a data storage apparatus.

Preferably, the data storage apparatus comprises a storage controller apparatus.

Preferably, the data storage apparatus comprises a storage virtualization controller apparatus.

Preferably, the node comprises a host processing apparatus. Preferably, at least one of the old version of application software and the new version of application software comprises a shared library.

In a third aspect, the present invention provides a computer program comprising computer program code to, when loaded into a computer system and executed thereon, cause the computer system to perform the steps of a method according to the second aspect.

In a preferred embodiment, the present invention separates the software into two elements, high level application software and low level infrastructure software. The high level application software may be packaged as a shared library which can be loaded and unloaded by the low level infrastructure software. The API between the high level application software and the low level infrastructure is preferably constrained so that the low-level software can support a range of older versions of high level application shared libraries. The division takes into consideration the fact that the high level application software is typically responsible for defining the majority of the behaviors that make software upgrade compatibility difficult.

Preferred embodiments of the present invention are of particular industrial utility in data storage environments, such as data storage apparatus, data storage controllers, and storage virtualization controllers, which are typically attached to one or more host processors. However, it will be clear to one of ordinary skill in the art that further embodiments may be implemented with advantage in other clustering and networking environments.

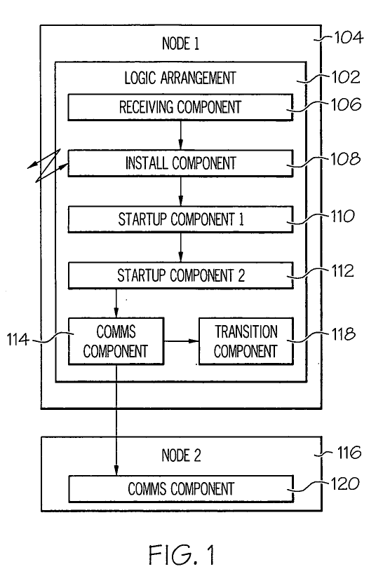

Turning to FIG. 1, there is shown a logic arrangement 102 in a node 104 (NODE 1) operable in a distributed computing system, and having a receiving component 106 for receiving a new version of application software and a new version of infrastructure software. The logic arrangement 102 further comprises an installation component 108 for installing the new version of application software and the new version of infrastructure software, and a first startup component 110 for starting the new version of infrastructure software. A startup component, as would be understood by one of ordinary skill in the art, typically loads software into memory and starts its execution.

The logic arrangement includes a second startup component 112 for starting an old version of application software to run with the new version of infrastructure software. There is also provided a first communication component 114 for receiving an indicator from a further node 116 (NODE 2) to indicate that the new version of application software and the new version of infrastructure software has been installed at further node 116.

The logic arrangement also provides a transition component 118 responsive to the first communication component 114 for quiescing the old version of application software, unloading the old version of application software and loading the new version of application software. The loaded application software is then ready for execution.

The logic arrangement may also comprise a second communication component 116 (illustrated in NODE 2 116 for convenience of understanding) for sending an indicator to node 104 to indicate that the new version of application software and the new version of infrastructure software has been installed at NODE 2 116.

It will be clear to one of ordinary skill in the art that the elements shown for convenience in NODE 1 104 and NODE 2 116 are preferably combined in a single node, such that the node may act both as a sender of the indicator and the receiver of the indicator, thus enabling the nodes to act as peers in co-ordinating the software upgrade.

As can be seen from the above, an upgraded software package includes both the application software and the infrastructure software elements. The upgrade process may thus include the following steps:
1. The new versions of high level and low level software are distributed to each node in the system;
2. Each node in turn installs the new software package, and then boots to the new low-level software but the old high level application software, for example as a shared library; and
3. Once each node has the new software package installed, all nodes perform a coordinated transition where they unload the old shared library, and load the new high level application software shared library.

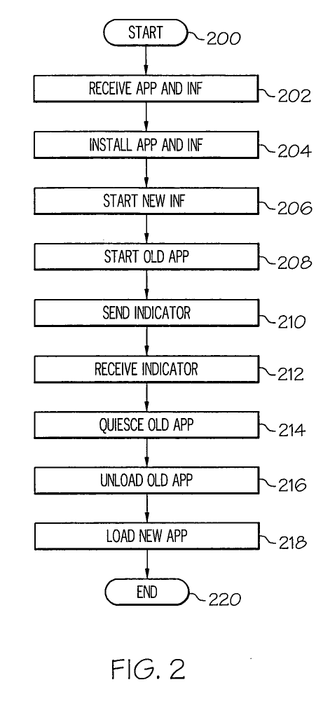

Turning now to FIG. 2, there is shown a method for software upgrade in a node operable in a distributed computing system. The process commences at START 200. At step 202, a new version of application software and a new version of infrastructure software is received by the receiving component. At step 204, an installation component installs the new version of application software and the new version of infrastructure software. At step 206, a first startup component operates to start the new version of the infrastructure software. Having started the new infrastructure software running, the method proceeds at step 208, when a second startup component operates to start an old version of application software to run with the new version of infrastructure software. At step 210, an indicator is sent to one or more communicating nodes to indicate the upgrade status of the present node. The old application software continues to run on the new infrastructure until step 212, at which an indicator is received by a first communication component from a further node to indicate that the new version of application software and the new version of infrastructure software has been installed at the further node. At this point in the process, the node is prepared to complete the upgrade in coordination with the further node. Responsive to receipt of the indicator a transition component at step 214 quiesces the old version of application software, unloads at step 216 the old version of the application software, and loads at step 218 the new version of application software. The upgrade is thus complete and the process terminates at END 220.

The method as described above preferably comprises the step 210 of sending, by a second communication component, an indicator to the further node to indicate that the new version of application software and the new version of infrastructure software has been installed at the node, and thus that the node is prepared for the coordinated upgrade to complete. It is, however, contemplated that other methods may be used to complete the upgrade, such as, for example, by setting a timer at each node in synchronization with other nodes and waiting for its expiry before completing the upgrade. It will be clear to one skilled in the art that various heartbeat, timer and lease-governed techniques may equally be used to achieve the required benefits of concurrency, in addition to the direct signalling mechanism explicitly disclosed herein.

It will be clear to one of ordinary skill in the art that the presently-described steps are merely preferred, and that various alternatives are possible within the sequence and structures by which the software upgrade may be effected.

While the software upgrade is in progress, the system exhibits old behavior because all nodes are running the old shared library. Therefore the problems associated with incompatibilities in this software are eliminated. After the upgrade the system continues operation with the new high level application software and again incompatibilities between nodes in this software are eliminated.

The process of loading and unloading a shared library is much quicker than normal system initialisation (often many seconds or minutes), and therefore takes place without disrupting application service. After the upgrade the system continues operation with the new high level application software and again incompatibilities between nodes in this software are eliminated.

Though this can be applied to any system it offers particular advantage where the system is constructed with a number of constraints:
1. The low-level infrastructure software must still maintain backwards compatibility. It is advantageous if this is stable well-proven code or if it represents a small proportion of the total system software.
2. The interface between the low-level and high-level software must be maintained through multiple versions so it is advantageous if this is inherently small, and if it changes from old version to new version primarily by growing (adding new function) rather than removing or changing functions. Any changes must be made so as to retain backwards compatibility. Data structures shared between the APIs cannot be changed.
3. The low-level infrastructure must control the operation of the high-level such that it is able to quiesce its operation, such that there are no threads executing or blocked within the application or shared library; no data references are being made to data elements within the shared library; and hence the old shared library can be unloaded under the control of the low-level application.

It will be clear to one skilled in the art that the method of the present invention may suitably be embodied in a logic apparatus comprising logic means to perform the steps of the method, and that such logic means may comprise hardware components or firmware components.

It will be appreciated that the method described above may also suitably be carried out fully or partially in software running on one or more processors (not shown), and that the software may be provided as a computer program element carried on any suitable data carrier (also not shown) such as a magnetic or optical computer disc. The channels for the transmission of data likewise may include storage media of all descriptions as well as signal carrying media, such as wired or wireless signal media.

The present invention may suitably be embodied as a computer program product for use with a computer system. Such an implementation may comprise a series of computer readable instructions either fixed on a tangible medium, such as a computer readable medium, for example, diskette, CD-ROM, ROM, or hard disk, or transmittable to a computer system, via a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrink-wrapped software, pre-loaded with a computer system, for example, on a system ROM or fixed disk, or distributed from a server or electronic bulletin board over a network, for example, the Internet or World Wide Web.

It will also be appreciated that various further modifications to the preferred embodiment described above will be apparent to a person of ordinary skill in the art.

What is claimed is:

1. An apparatus for software upgrade in a first node operable in a distributed computing system, comprising:
a receiving component for receiving a new version of application software and a new version of infrastructure software;
an installation component for installing the new version of application software and the new version of infrastructure software;
a first startup component for starting the new version of infrastructure software;
a second startup component for starting an old version of application software to run with the new version of infrastructure software; and
a transition component, responsive to an indication from a second node that the new version of application software and the new version of infrastructure software have been installed at the second node, for quiescing the old version of application software in the first node, unloading the old version of application software from the first node and loading the new version of application software to the first node.

2. The apparatus of claim 1, further comprising a communication component for sending an indication to the second node that the new version of application software and the new version of infrastructure software have been installed at the second node.

3. The apparatus of claim 1, wherein the first node comprises a data storage apparatus.

4. The apparatus of claim 3, wherein the data storage apparatus comprises a storage controller apparatus.

5. The apparatus of claim 3, wherein the data storage apparatus comprises a storage virtualization controller apparatus.

6. The apparatus of claim 1, wherein the first node comprises a host processing apparatus.

7. The apparatus of claim 1, wherein at least one of the old version of application software and the new version of application software comprises a shared library.

8. A method for software upgrade in a first node operable in a distributed computing system, said method comprising the steps of:
receiving, by a receiving component, a new version of application software and a new version of infrastructure software;
installing, by an installation component, the new version of application software and the new version of infrastructure software;
starting, by a first startup component, the new version of infrastructure software;
starting, by a second startup component, an old version of application software to run with the new version of infrastructure software; and
responsive to an indication from a second node that the new version of application software and the new version of infrastructure software have been installed at the second node, quiescing, by a transition component, the old version of application software, unloading the old version of application software and loading the new version of application software.

9. The method of claim 8, further comprising the step of sending an indication to the second node that the new version of application software and the new version of infrastructure software have been installed at the second node.

10. The method of claim 8, further comprising storing data in a data storage apparatus.

11. The method of claim 10, further comprising storing the data in a data storage apparatus comprising storage controller apparatus.

12. The method of claim 10, further comprising storing the data in a data storage apparatus comprising a storage virtualization controller apparatus.

13. The method of claim 8, further comprising using a node comprising a host processing apparatus.

14. The method of claim 8, wherein the receiving step further comprises receiving at least one of the old version of application software and the new version of application software comprises a shared library.

15. A machine-readable medium having a plurality of instructions processable by a machine embodied therein, wherein the plurality of instructions, when processed by the machine, causes the machine to perform a method, the method comprising:
receiving, by a receiving component, a new version of application software and a new version of infrastructure software;
installing, by an installation component, the new version of application software and the new version of infrastructure software;
starting, by a first startup component, the new version of infrastructure software;
starting, by a second startup component, an old version of application software to run with the new version of infrastructure software; and
responsive to an indication from a second node that the new version of application software and the new version of infrastructure software have been installed at the second node, quiescing, by a transition component, the old version of application software, unloading the old version of application software and loading the new version of application software.

16. The machine-readable medium of claim 15, the method further comprising the step of sending an indication to the second node that the new version of application software and the new version of infrastructure software have been installed at the second node.

17. The machine-readable medium of claim 15, the method further comprising storing data in a data storage apparatus.

18. The machine-readable medium of claim 17, the method further comprising storing the data in a data storage apparatus comprising storage controller apparatus.

19. The machine-readable medium of claim 17, the method further comprising storing the data in a data storage apparatus comprising a storage virtualization controller apparatus.

20. The machine-readable medium of claim 15, the method further comprising using a node comprising a host processing apparatus.
